(19) United States
(12) Patent Application Publication
(10) Pub. No.: US 2016/0300027 A1
(43) Pub. Date: Oct. 13, 2016

(54) OPERATOR-SPECIFIC ADAPTATION OF A MEDICAL ALALYZER USER INTERFACE

(71) Applicant: RADIOMETER MEDICAL APS, Brønshøj (DK)

(72) Inventors: Torben Haugaard JENSEN, Brønshøj (DK); Jacob Givskov HANSEN, Brønshøj (DK); Jakob SKRIVER, Brønshøj (DK)

(21) Appl. No.: 15/036,430

(22) PCT Filed: Nov. 14, 2014
(86) PCT No.: PCT/EP2014/074625

§ 371 Date: May 13, 2016

(30) Foreign Application Priority Data
Nov. 15, 2013 (DK) PA201300649

(51) Int. Cl. G06F 19/00; G01N 35/00

(52) U.S. Cl. CPC G06F 19/3406; G06F 19/366; G01N 35/00871; G01N 35/00623; G06F 19/327; G01N 2035/00881; G01N 2035/0091

(57) ABSTRACT

The invention relates to a method of operating a set of one or more medical analyzers each operable to analyze one or more specimens upon login of one of a set of one or more operators. The method comprises: verifying identification of said operator; collecting one or more sets of performance history data associated with the logged-in operator, each set associated with an operational task performed by one of the set of medical analyzers when operated by said one or more operators, the performance history data being indicative of one or more performance measures of operating the medical analyzer; determining, from at least the collected performance history data, one or more operator preferences or operator proficiency indicators indicative of a level of proficiency of the one or more operators; and automatically adapting, responsive to the determined one or more operator preferences and/or proficiency indicators, one or more elements of a user interface of at least a first one of the set of medical analyzers when said first medical analyzer is operated by one of the one or more operators.

### TECHNICAL FIELD

Embodiments of the methods, product means, systems and analyzers disclosed herein relate to the field of medical analyzers for analyzing specimens, in particular multi-operator analyzers for use in a clinical, point-of-care (POC) or laboratory environment.

### BACKGROUND

Within the field of clinical analysis, a wide variety of electronic medical analyzers are known that allow clinical personnel to acquire test results and/or measurement results or otherwise analyze specimens such as samples of bodily fluids. These analyses includes in vitro measurements on individual samples of e.g. whole blood, serum, plasma and urine, tissue samples or other types of samples obtained from a patient. Further, the analysis include in vivo measurements on sample streams such as transcutaneous measurements of e.g. the partial pressures of oxygen (pO₂) and/or carbon dioxide (pCO₂) and also pulse oximetry measurements. Generally, a medical analyzer is a device which conducts chemical, optical, physical or similar analysis on specimen e.g. on individual samples or sample streams. Such medical analyzers include analyzers for performing various forms of clinical tests and/or analysis, such as the measurement of physiological parameters of a patient.

In modern clinical environments, medical analyzers are widely used and there is a trend of moving more and more tests from a central laboratory to the actual point of care (POC). Even though this has a number of advantages, it also involves a number of challenges. For example, the operational environment in which POC medical analyzers are operated is less controllable than the environment of a central laboratory, e.g. in terms of controlling the personnel operating the devices. Furthermore, any medical analyzer may be operated by a number of different operators during the course of a day. Some of the operators may be experienced and operate the device on a regular basis while others may use the medical analyzer less frequently.

Generally it is desirable to ensure the quality of the measurement results or other output of these analyzers. At the same time, any such analyzer should be operable as efficiently as possible so as to reduce any unnecessary time spent by the individual operator with the analyzer.

US 2013/0024247 disclose an analyzing system comprising an analyzer and a host system. The analyzer requests confirmation as to whether the operator operating the analyzer has completed training. If the operator has not completed the training, the analyzer prevents measurement of a sample.

Hence, while the above prior art system may prevent untrained operators from operating an analyzer, it remains desirable to increase the quality and/or efficiency of operation of the analyzer, even when operated by an operator that has performed the required training.

### SUMMARY

Disclosed herein are embodiments of a method of operating a set of one or more medical analyzers each operable to analyze one or more specimens upon login of one of a set of one or more operators; the method comprising:
verifying identification of said operator;- collecting one or more sets of performance history data associated with the logged-in operator, each set associated with an operational task performed by one of the set of medical analyzers when operated by said one or more operators, wherein the operational task comprises an analysis of one or more specimens and/or maintenance tasks, the performance history data being indicative of one or more performance measures of operating the medical analyzer;
determining, from at least the collected performance history data, one or more operator preferences and/or proficiency indicators indicative of a level of proficiency of the one or more operators; and
automatically adapting, responsive to the determined one or more operator preferences and/or proficiency indicators, one or more elements of a user interface of at least a first one of the set of medical analyzers when said first medical analyzer is operated by said operators.

Consequently, embodiments of the method disclosed herein determine a preference or level of proficiency of an operator, or a group of operators, of a medical analyzer and adapt one or more elements of a user interface of the medical analyzer based on the determined proficiency indicator and/or operator preference. The determination of the proficiency indicator and/or operator preference is based on collected performance data of the medical analyzer (or of other, similar medical analyzers within the same clinic, site or other entity) when operated by the same operator or group of operators. For example, when an operator logs on to or otherwise activates the analyzer, the operator history may thus automatically be evaluated or the results of a previous evaluation may be obtained. Consequently, inexperienced operators or operators who have previously operated the medical analyzer with poor results may be presented with a user interface that provides a high level of guidance, while experienced operators who have previously used the analyzer with consistently good results may be presented with a user interface that provides less guidance and allows for a faster operation of the analyzer. When the user interface is based on a determination of the proficiency of the operator from the actual usage history of the operator, operators are automatically presented with a customized user interface for facilitating high-quality analysis results even for less experienced operators while ensuring efficient operation for experienced operators.

Hence, embodiments of the method disclosed herein result in fewer errors and improved quality of sample preparation while maintaining a relatively short average process time.

The operational task may comprise an analysis of one or more specimens and/or a maintenance task such as cleaning, replacing and/or adding parts, consumables etc. It will be appreciated that different criteria for determining a proficiency level may be used for different types of tasks. Similarly, the determination of proficiency indicators for different operational tasks may be based on different performance history data. An operational task may comprise one or more steps.

In some embodiments, the method further comprises storing the collected one or more sets of performance history data by a data processing system communicatively connected with each of the one or more medical analyzers. This allows performance history data associated with a specific operator or with a group of operators (e.g. a predetermined sub-group of operators or even all operators) to be collected from multiple analyzers, e.g. multiple analyzers of the same type. The determination of the operator's proficiency indicator(s) and/or operator preferences may thus be based on the operator's performance history on all analyzers of a given type or group, thus resulting in a more accurate determination of the operator's proficiency indicator(s) and/or operator preferences. Generally, in some embodiments, the method comprises collecting performance history data associated with a plurality of medical analyzers, and the one or more proficiency indicators and /or preferences of the one or more operators are determined from performance history data that is collected from said plurality of medical analyzers. For example, an experienced operator may normally operate a particular analyzer within a clinic and only infrequently use a different analyzer of the same type but located at a different position within the clinic. A central storage of the operator's performance history for all analyzers allows the infrequently used analyzer to present an operator interface for advanced operators to the experienced operator, even though it may be the first time the operator uses this particular analyzer.

The performance history data may comprise any suitable type of data indicative of the performance of a specific medical analyzer or specific type of medical analyzer when operated by a specific operator; the data can be collected by the individual analyzer and/or by a central processing system. Examples of performance history data may include:
One or more error codes generated by the medical analyzer; this data may e.g. be used to evaluate a frequency of occurrence of certain error codes.
One or more quality parameters indicative of a result of the analysis of a specimen; for example, some analyzers may generate a confidence level or error margin indicative of an estimated accuracy of the performed measurement; alternatively or additionally, some analyzers may be capable of detecting an error or deficiency of one or more steps of the operational task, e.g. a sample preparation step performed prior to the actual measurement.
Performance data indicative of a quality of a specimen preparation step prior to bringing the specimen into contact with the medical analyzer; for example, some analyzers may be capable of detecting likely errors or deficiencies in the preparation of a sample, such as inadequate storing (e.g. at an inadequate temperature or otherwise under inadequate conditions and/or for a too long or too short period of time, etc.)
Timing information indicative of a time spent by the one or more operators for performing one or more predetermined tasks; to this end, the medical analyzer may comprise a timer operable to determine the time elapsed between start and finish of a task and/or of individual steps of a task.
An indication and/or an order of steps performed by the operator when operating the medical analyzer.
Profile data of the operator, e.g. an identification of what training the operator has undergone, the time since the last training, etc.
A measure of the frequency of performance of the operational task by the operator, such as an elapsed time since a previous performance of the operational task by said operator and/or a number of times of performance of the operational task by the operator in a specific time period.

The determination of a proficiency indicator may be performed based on a set of predetermined rules or functions, allowing the medical analyzer or other processing system to determine a proficiency indicator from the performance history data. It will be appreciated that a plurality of suitable rules or mappings may be defined. For example, in some embodiments, determining the one or more proficiency indicators comprises comparing the collected performance history data with one or more reference criteria, and selecting a proficiency level from a set of proficiency levels responsive to said comparison. In a specific example, the performance history data may comprise the number of error codes of a specific type generated by the medical analyzer during a given operational task performed by the operator during a predetermined time interval, and the total number of times the operator has performed said operational task during said time interval. The process may thus compute the frequency of occurrences of the error code, compare the computed frequency with one or more predetermined threshold frequencies and determine a proficiency level based on the comparison. The reference criteria may be absolute criteria or a relative criteria relative to a peer group of operators, e.g. compared to an overall frequency of a specific errors across all operators and all analyzers (e.g. all analyzers at the same ward, department or at the same site or even globally for all analyzers of a certain make or model) and/or during specific periods of time, such as time of day, or time of week.

In some embodiments, determining the one or more proficiency indicators comprises processing the performance history data so as to identify one or more likely operational deficiencies in the operation of the medical analyzer. For example, in some situations, certain error codes, combinations of error codes, and/or other collected data may allow the medical analyzer or another data processing system to determine a likely cause of the error. For example, certain error codes or combinations of error codes or certain measurement results may be known to be typical for a certain deficiency in preparing the sample.

The determination of preferences and/or performance indicators may be performed responsive to an activation of the analyzer by an operator. Alternatively, the determination may be performed every time an operator has completed a task. Yet alternatively, the determination may be performed at regular time intervals, e.g. once a day or once a week.

It will be appreciated that a user interface may be adapted or modified in a variety of ways so as to accommodate the specific proficiency level or preferences of an operator. Generally, the user interface may include a graphical user interface and/or an otherwise visible user interface and/or an audible user interface and/or a physical interface. Examples of a visible user interface may include illuminated parts of the analyzer and/or LEDs which may e.g. be selectively illuminated in different colors, blinking patterns, etc. Here, the term physical user interface is intended to refer to elements and/or functionality of the analyzer that allow the operator to physically manipulate the medical analyzer and/or to manipulate a specimen relative to the analyzer. Examples of such a physical manipulation may comprise an operator-operated or operator-initiated movement of a movable part of the analyzer, insertion, placement, removal, or re-placement of specimen, analytes, liquids, replacement parts such as a sensor unit or parts thereof, etc., into, from or relative to the analyzer, operator-assisted processing or manipulation of a specimen by the medical analyzer, such as stirring, mixing, heating, cooling, filtering, aspiration, and/or the like. Hence, the physical user interface may comprise elements operable to perform movements of movable parts and/or to allow operator-operated or operator-initiated movement of moveable parts of the analyzer. For example, the analyzer may open or close an inlet allowing the operator to insert a sample; the analyzer may unlock, lock or otherwise selectively allow or prevent movable parts from being operated, and/or the like.

In some embodiments, the user interface comprises a graphical user interface adapted to display respective user interface elements each associated with one or more steps of an operator-controllable task or workflow performed by the medical analyzer; and adapting the user interface comprises adapting the number of user interface elements displayed for said operator-controllable task. For example, operators having a high proficiency level may be presented with fewer user interface elements than operators with a lower proficiency level. For operators having a lower proficiency level, the user interface may split up a task into a larger number of sub-steps so as to provide more guidance as to the order and/or nature of sub-steps to be performed.

In some embodiments, the user interface comprises a graphical user interface adapted to display respective user interface elements associated with one or more steps of an operator-controllable task performed by the medical analyzer; and wherein adapting the user interface comprises adapting a visual characteristic of one or more of the user interface elements displayed for said operator-controllable task. Examples of the visual characteristics may include the shape, color, and/or size of a user interface element such as a button, visual indicator, a text entry field, a message, etc. Other examples of visual characteristics may be a blinking, flashing or other visual effect. Yet other visual characteristics may include the content of an explanation, animation, image, video, etc., for example so as to provide guidance at different levels of detail.

In some embodiments, the user interface is operable to perform at least one user interface action at a predetermined speed; and wherein adapting the user interface comprises selecting said speed. For example, the user interface action may be an action of a graphical user interface, e.g. the presentation of a video, an animation, the scrolling of a text, the sequential display of different indicators, etc. Other examples of a user interface action may include physical movements, such as an automatic closing of a compartment or inlet, an automatic movement of a sample from a sample receiving unit to a measurement unit, etc. A slower movement may cause less confusion and may reduce the risk of the inexperienced operator interfering with the movement. Similarly, in some embodiments, adapting a timing of a user interface may include an embodiment wherein the user interface is operable to perform a sequence of user interface actions, and wherein adapting the user interface comprises adapting a timing of said user interface actions relative to each other. For example, inexperienced operators may be presented with longer pauses between steps, or certain steps will be extended in length compared to other steps, etc. When adapting the user interface comprises selecting one or more training presentations to be presented by the medical analyzer to the one or more operators, the operator may selectively be presented with training sessions that match the operator's performance history. For example the training session may be selected based on frequently occurring error codes or the like. For example, after an operator logs on to the analyzer, the operator history may be evaluated; based on the evaluation, appropriate training is activated if deemed necessary. The training may be in the form of a video, animation, instructions, etc. that is displayed directly on the medical analyzer. For example, in the context of blood gas analyzers, infrequent/new operators are more prone to making errors in the pre-analytical phase as well as in the aspiration of the blood sample, and some operators are in general more prone to making errors. By selectively providing training to those operators most prone to making errors, the number of errors can be limited, while avoiding unnecessary training of experienced operators.

In some embodiments, adapting comprises receiving an operator identification of an operator of the medical analyzer; and adapting the user interface responsive to the received operator identification and to the determined one or more proficiency indicators. Hence, the adaptation of the user interface may be based on specific performance history of a specific operator. Alternatively or additionally, the adaptation of the user interface may be based on the performance history of a group of operators or even of all operators. For example, in some embodiments, the adaptation of the user interface may further be based on one or more analyzer-specific criteria, such as the location where the analyzer is located (e.g. which ward within a hospital). Similarly, the determination of preferences and/or proficiency indicators may be performed based on collected input for an individual operator, a group of operators, or even all operators of the analyzer or analyzers fulfilling the analyzer criteria, e.g. of all analyzer on a specific ward of a hospital. It will be appreciated that, if the adaptation and/or data collection is performed globally for all operators, an operator registration/authentication may not be required.

In some embodiments, the adaptation of an element of a user interface may further be time-dependent, e.g. depend on the time of day or the time of week. For example, during night shifts or weekends, or at the beginning or end of a shift, the user interface may be changed.

Adapting the user interface may comprise disabling one or more functions of the medical analyzer, e.g. by disabling the corresponding elements of the user interface. For example, certain functions, e.g. certain maintenance functions or the measurement of certain parameters or certain types of specimen, may selectively be disabled based on an operator's performance history. The disabling may e.g. be cancelled or overridden by a super-operator or based on a predetermined event, e.g. the operator performing a corresponding training session. The training may e.g. be performed on the analyzer and/or on an external system. In any event, the system performing or facilitating the training may report the completion of the training back to the analyzer or to a central processing system.

In some embodiments, adapting comprises selecting a proficiency level from a number of available proficiency levels, each proficiency level having a user interface type associated with it. In other embodiments, the method may involve multiple proficiency indicators, e.g. associated with respective error codes, and individual parts or elements of the user interface may be adapted based on respective ones of the different proficiency indicators, thus facilitating a fine grained adaptation of the user interface to the specific needs of the individual operator.

Indicators of operator preferences may also be determined based on detected operator behavior, and determined operator preferences may result in a change of elements of the user interface of the analyzer. This may e.g. include the changing of default settings or the measuring setup to reflect the most commonly used settings/setup by an individual operator or a group of operators.

The present invention relates to different aspects including the method described above and in the following, corresponding apparatus, systems, and products, each yielding one or more of the benefits and advantages described in connection with the above-mentioned method and/or one of the other aspects, and each having one or more embodiments corresponding to the embodiments described in connection with the above-mentioned methods and/or one of the other aspects.

In particular, disclosed herein are embodiments of a medical analyzer for analyzing specimens and adapted to perform embodiments of the method described above and in the following.

Furthermore, disclosed herein are embodiments of a system comprising a data processing system and one or more medical analyzers as described herein. The term medical analyzer is intended to comprise any apparatus comprising processing means for data processing and an analyzer unit for analyzing a specimen, such as an analyzer for acquiring test data, for performing measurements of physiological parameters, for acquiring detected types and/or dosages of a medication, etc. Generally, embodiments of the medical analyzer may include a clinical instrument for performing clinical tests and/or analysis, a drug dispensing analyzer, and/or another medical analyzer for clinical use. In some embodiments, the medical analyzer is an analyzer for analyzing samples of bodily fluids, such as whole blood, plasma, serum, urine, pleura, transcutaneous gases or expired air. Embodiments of an analyzer may analyze individual specimen or perform a continuous monitoring e.g. based on a continuous flow or stream of specimen.

Embodiments of the medical analyzer may further comprise a storage medium, e.g. a hard disc, an optical disc, a compact disc, a DVD, a memory stick, a memory card, an EPROM, a flash disk, and/or the like. Some embodiments of the medical analyzer further comprise a user interface such as a display for presenting a graphical user interface and/or circuitry for providing an audible user interface, or circuitry or analyzers for providing a physical user interface such as an analyzer for receiving a specimen and/or an analyzer for an operator assisted preparation or processing of a specimen.

It will be appreciated that some embodiments of an analyzer may comprise the user interface, the processing means and the analyzer unit accommodated within a single analyzer such as within a single housing. In other embodiments, different components of the analyzer may be distributed across different entities or analyzers. For example, in some embodiments, the analyzer may comprise a first device comprising the analyzer unit and, optionally, a user interface. The first device may be communicatively connectable to a second device, e.g. a computer or other data processing system, comprising the processing means. In some embodiments, at least a part of the user interface may be provided by a separate device, e.g. a handheld device carried by the operator and communicatively connectable with the analyzer unit and/or the processing means. The handheld device may e.g. be a smartphone, a tablet, a portable computer, a mobile phone, or the like, executing a suitable application.

It is noted that the features of the methods described herein may be implemented in software and carried out on a data processing system or other processing means caused by the execution of program code means such as computer-executable instructions. Here and in the following, the term processing means comprises any circuit and/or device suitably adapted to perform the above functions. In particular, the above term comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

Hence, according to another aspect, a computer program comprises program code means adapted to cause a medical analyzer or other data processing system to perform the steps of the method described herein, when said computer program is run on the medical analyzer or data processing system. For example, the program code means may be loaded in a memory, such as a RAM (Random Access Memory), from a storage medium or from another computer via a computer network. Alternatively, the described features may be implemented by hardwired circuitry instead of software or in combination with software.

### BRIEF DESCRIPTION OF THE DRAWINGS

The above and other aspects will be apparent and elucidated from the embodiments described with reference to the drawing in which:

FIG. 1 shows a schematic block diagram of an example of a system of medical analyzers.

FIG. 2 shows a schematic functional block diagram of an embodiment of a medical analyzer.

FIG. 3 shows a flow diagram of an example of a method of operating a medical analyzer.

FIG. 4 shows a schematic block diagram of a rule engine implemented by a data processing system.

FIG. 5 shows a schematic block diagram of another rule engine implemented by a data processing system.

FIG. 6 shows a flow diagram of another example of a method of operating a medical analyzer.

### DETAILED DESCRIPTION

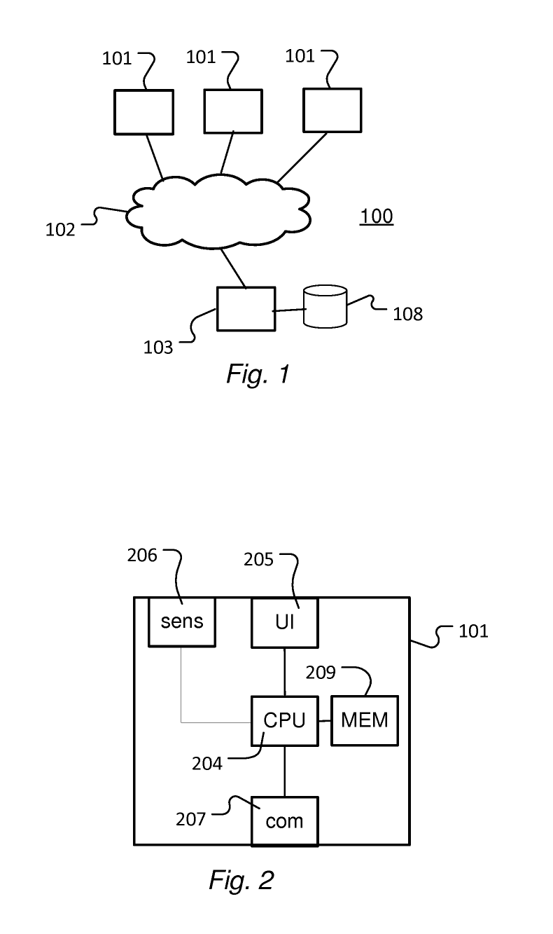

FIG. 1 shows a schematic block diagram of an example of a system of medical analyzers. The system, generally designated 100, comprises a host system 103, e.g. a server computer or other suitable data processing system suitably programmed to store and maintain usage history data of operators of medical analyzers in a suitable database system 108. The host system 103 is connected to a computer network 102, e.g. a wired or wireless local area network (LAN), a wide area network, or the like. The connection may be wired or wireless. The system further comprises a number of medical analyzers 101 each connected or connectable to the computer network 102. The medical analyzers may be connectable to the computer network 102 via a wired connection, e.g. via a local area network interface circuit, or via a wireless connection, e.g. via a wireless access point. In the example of FIG. 1, the system comprises three medical analyzers 101. It will be appreciated, however, that embodiments of the system described herein may comprise any number of medical analyzers, each being connectable to the computer network via a suitable communications interface. The analyzers may all be of the same type or they may be of different types. It will further be appreciated that the host system and, optionally, the database system may be integrated into one of the medical analyzers. Alternatively, one, some or each medical analyzer may be suitably configured to perform some or all of the functionality of the host system and be communicatively connected to a central database 108. It will be appreciated that, in embodiments where all analyzers include the functionality of the host system, a network interconnecting the analyzers with each other or a separate host system may be omitted. Each medical analyzer may be a suitably configured clinical instrument, such as a blood gas analyzer or another form of analyzer for analyzing specimen such as bodily fluids, e.g. whole blood, serum, plasma, pleura and urine.

FIG. 2 shows a schematic functional block diagram of an embodiment of a medical analyzer 101, e.g. a medical analyzer of the system of FIG. 1. The medical analyzer 101 is connectable to a host system via a suitable communications link allowing data communication between the medical analyzer 101 and the host system. To this end, the medical analyzer comprises a communications interfaces 207 allowing data communications via a communications link. Generally, examples of suitable communications interfaces include a wired or wireless network adapter, a radio-frequency communications interface allowing communication via a telecommunications network such as a cellular communications network, a radio-frequency communications interface allowing communication via a short-range wireless communications interface, a serial or parallel interface adapter, a USB port, and/or the like.

The medical analyzer 101 further comprises a processing unit 204 such as a suitably programmed CPU or microprocessor or other suitable processing means, communicatively coupled to the communications interface 207. The medical analyzer 101 further comprises a data storage device 209, e.g. a RAM, an EPROM, a hard disk, etc., communicatively coupled to the processing unit 204 for storing program code and data.

The medical analyzer 101 further comprises a user interface 205 operationally coupled to the processing unit 204 and allowing an operator to interact with the medical analyzer. The user interface may include a display such as a touch screen for displaying information, selectable menu items allowing an operator to select operational options, enter parameters, and/or the like. The user interface may be operable to present measurement results to the operator, to request operator inputs or other operator actions, to present selectable options and/or to present instructions to the operator. The user interface may further comprise a keypad, buttons, and/or user interface devices. Additionally or alternatively, the user interface may comprise devices allowing the operator to feed or insert a specimen into the device, or to otherwise bring a specimen in operational connection with the device, and/or to process a specimen, move a specimen between processing steps, remove a specimen, perform maintenance tasks etc.

The medical analyzer 101 further comprises a specimen processing and analysis unit 206 communicatively coupled to the processing unit 204 and operable to process a specimen and to acquire test data, measurements of physiological parameters, detected types and/or dosages of a medication, and/or the like. For example, the specimen processing and analysis unit 206 may comprise a blood gas analyzer unit, an analyzer unit for measuring cardiac, coagulation, infection and/or pregnancy markers, a transcutaneous monitor such as a TCM monitor by Radiometer Medical ApS, and/or the like. It will be appreciated that specimen processing and analyzing units for a large variety of parameters are known as such, e.g. the ABL90 FLEX or the AQT90 FLEX analyzers by Radiometer Medical ApS.

It will be appreciated that some analyzers may not include all the elements described above in a single analyzer. For example, some medical analyzers may only comprise an analyzing unit communicatively connected to a separate data processing system. The user interface may be provided by the analyzer comprising the analyzing unit and/or by the separate processing unit and/or by yet another, separate unit, such as a hand-held device. For the purpose of the present description, the term analyzer is also intended to comprise such analyzers whose functionality is distributed over two or more physical modules.

Embodiments of operating a system of medical analyzers, e.g. a system as described in FIG. 1, will now be described in more detail.

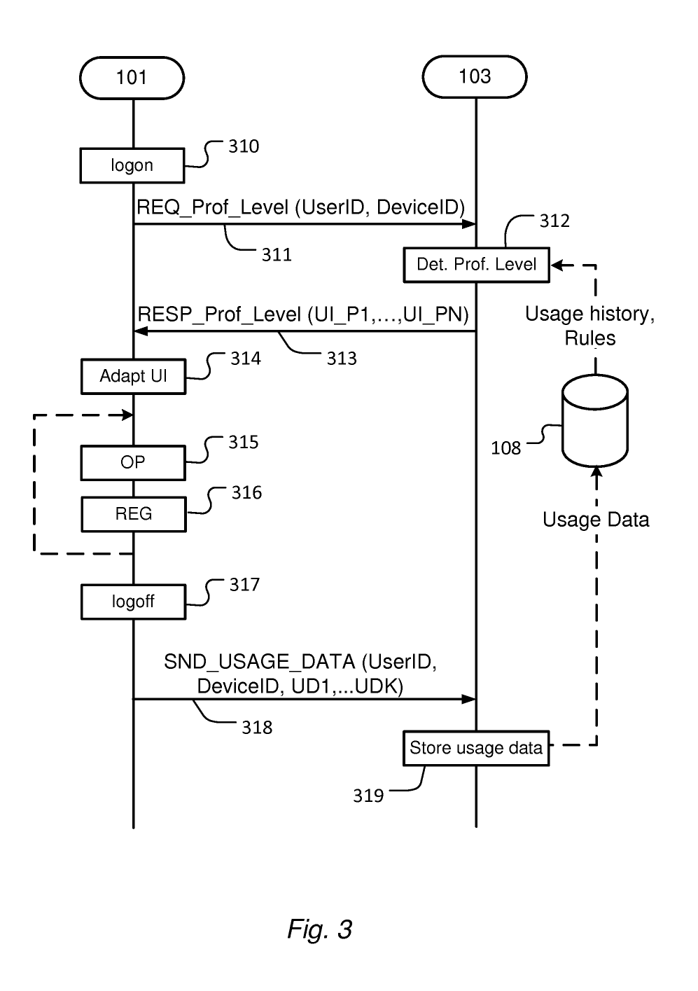

FIG. 3 shows a flow diagram of an example of a method of operating a medical analyzer, e.g. the analyzer of FIG. 2, of a system of medical analyzers, e.g. the system of FIG. 1. The process is performed by a system comprising a medical analyzer 101 and a host system 103 operationally coupled to a database system 108.

In initial step 310, the operator logs onto the medical analyzer, e.g. by providing suitable operator credentials, such as an operator ID, optionally supplemented by a password, biometric data or other means of authenticating an operator. The operator credentials may be entered manually by the operator or provided by a barcode, NFC, biometric technique, or other means of automatically providing operator credentials.

Upon successful operator registration, the medical analyzer sends a request 311 for operator proficiency information to the host system 103. The request comprises the operator ID and an analyzer ID or other suitable information allowing the host system 103 to identify the operator and the analyzer, or at least the type or model of medical analyzer to which the operator has logged on. It will be appreciated that, in some embodiments, the request does not need to include any analyzer ID. This may e.g. be the case in embodiments where the functionality of the host system is included in the medical analyzer or in embodiments where all medical analyzers included in a system are of the same type or at least have the same adaptable user interface elements. Similarly, in some embodiments, an operator ID may not be required, e.g. in embodiments, where the adaptation of the user interface is based on a usage history of all operators, e.g. grouped by analyzer, department, location of the analyzer, time-of-day, time-of-week, etc. It will further be appreciated that the operator proficiency information or operator preferences may be received in a different manner. For example, the analyzer may regularly receive and store updated proficiency and preference information for all operators, thus avoiding the need to request and receive the information from an external entity during log-in.

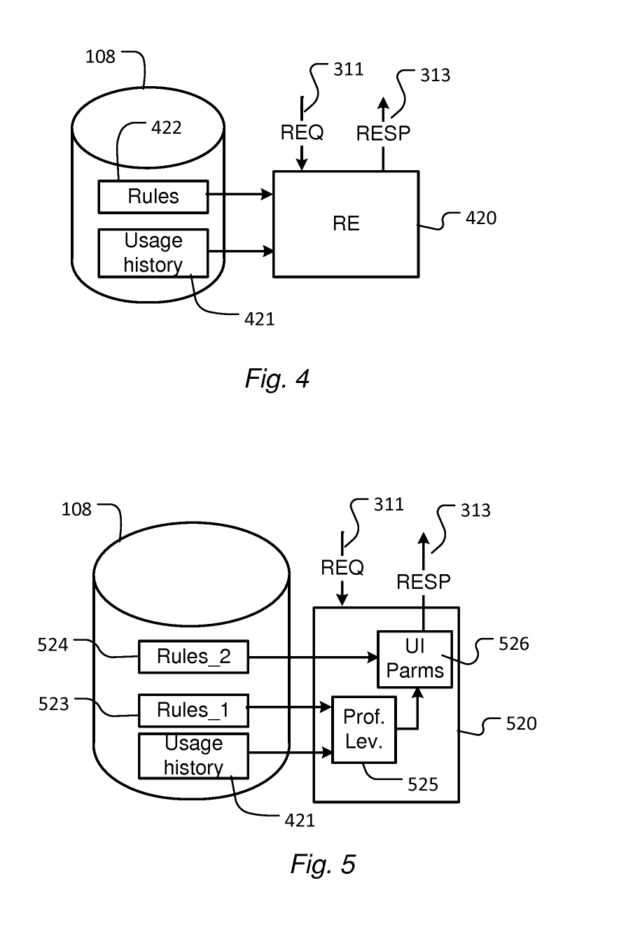

Upon receipt of the request 311, in step 312 the host system 103 determines a proficiency level or other proficiency indicators of the operator identified by the operator ID when operating the medical analyzer identified by the analyzer ID. To this end, the host system obtains usage history data associated with the operator ID and analyzer ID from a database 108. The determination may be based on a set of predetermined rules which the host analyzer may also obtain from the database 108 or which may be pre-configured in the host system. An example of stored usage history data, of determination rules and of a process for determining proficiency indicators will be described below with reference to FIGS. 4-5. The determination of the proficiency level or indicators may result in a number of user interface parameters associated with the determined proficiency level or indicators, e.g. timing parameters determining the relative timing of respective user interface actions, speed parameters determining the speed at which certain user interface actions are performed, pointers to presentation animations or videos to be presented to the operator, and/or the like. The host system 103 then returns a response message 313 to the medical analyzer, where the response message comprises the determined user interface parameters. It will be appreciated that, in alternative embodiments, the host system may determine one or more proficiency levels or indicators and return the determined proficiency level or indicators to the medical analyzer, thus causing the medical analyzer to determine the matching user interface parameters based on the received proficiency level or indicators. It will be appreciated that the determination of the proficiency level or operator preference may be performed at a different point during the process. For example, in some embodiments, task-specific proficiency levels may be determined. Consequently, the proficiency level and, thus adaptation of the user interface, may be performed responsive to the operator selecting or otherwise initiating a given operational task.

In any event, in subsequent step 314, the medical analyzer adapts the user interface of the medical analyzer based on the received user interface parameters or proficiency level/indicators. In subsequent step 315, the medical analyzer starts normal operation implementing the adapted user interface. The operation may comprise one or more processing and/or analysis steps for processing and/or analyzing a specimen under the control of the operator.

During the operation of the medical analyzer, the medical analyzer 101 collects one or more performance parameters (step 316), such as error codes, indications of operations that are repeated several times, success rates, number of successful operations, etc. The operator may perform one or several operational tasks, i.e. steps 315 and 316 may be repeated several times before the operator logs off from the analyzer (step 317). The logoff may be performed by an active action by the operator or automatically, e.g. after a predetermined time-out period, or by any other suitable mechanism.

Upon logoff, the medical analyzer 101 sends a log message 318 to the host system 103 comprising the collected performance data and, optionally, additional log data such as measurement results, etc.

It will be appreciated that the medical analyzer may send performance data after each operational task, e.g. as part of step 316, instead of in connection with the logoff routine. Hence, in such an embodiment, there may be no need for any logoff step. Alternatively or additionally, the medical analyzer may send performance data at other intervals, e.g. daily where the medical analyzer sends a daily performance report including performance data of respective operators and/or operator sessions.

In any event, upon receipt of the performance data, the host system 103 stores the received performance data in the database so as to update the usage history (step 319).

It will be appreciated that the usage history may be stored in the database 108 in a variety of ways. For example, the database 108 may have stored therein a table of usage events, e.g. as illustrated in table 1 below.

TABLE 1
Example of usage history log

| Oper- | Ana- | | | | | | |
|---|---|---|---|---|---|---|---|
| ator | lyzer | | | Task | | | |
| ID | ID | Start | Finish | ID | Error | Results | . . . |
| 1012 | 7 | 09:35:10 | 09:38:30 | 89 | — | [15, . . . , 1.35] | . . . |
| 1065 | 7 | 09:45:25 | 09:50:10 | 56 | — | [16, . . . , 1.37] | . . . |
| 1012 | 5 | 11:15:07 | 11:20:10 | 89 | 135 | [18, . . . , 2.05] | . . . |
| . . . | . . . | . . . | . . . | | . . . | . . . | . . . |

Each record in the table represents an operation performed by a specific operator on a specific analyzer. Each record may thus comprise an operator ID identifying the operator, an analyzer ID identifying the analyzer, time stamps identifying a start time of the operation and a completion time, a task ID identifying which specific task has been performed by the analyzer, and/or further data indicative of one or more results of the operational task, such as one or more of the following: error codes, result codes, result values, time stamps allowing the calculation of individual sub-tasks, and/or the like.

Based on the above usage history data, the host system may compute usage history statistics indicative of the proficiency level of individual operators or groups of operators e.g. when operating analyzers of a given type or model. These usage statistics may e.g. comprise the average duration of a given task or sub-task when performed by a given operator, the frequency of occurrence of certain error codes, the deviation of certain quality parameters from target values, and/or other performance measures. The host system may perform these computations at regular intervals, e.g. once a day, or when triggered by certain events, e.g. every time a new set of usage data is received, or upon request, e.g. upon receipt of a request for providing a proficiency level from an analyzer. Hence, the usage statistics may be pre-computed and stored in the database or computed upon request.

FIG. 4 shows a schematic block diagram of a rule engine implemented by a data processing system, e.g. by host system 103 of FIG. 1. The rule engine process 420 receives a request 311 from a medical analyzer for providing user interface parameters, where the request identifies an operator (or operator group) and a medical analyzer. Responsive to the request, the rule engine determines the analyzer type or model of the analyzer (e.g. by means of a look-up in a suitable table of the database 108) and retrieves relevant records of a usage history log 421 stored in database 108. The usage history log 421 may e.g. be stored as a table as illustrated in table 1 above, and the rule engine 420 may obtain all records pertaining to the identified operator and to analysers of the same type as the identified analyzer. The rule engine 420 further obtains a set of rules 422 pertaining to the identified analyzer type. The set of rules 422 may e.g. be stored as respective tables, one for each analyzer type. Each analyzer type may allow for adapting certain user interface features, and the possible ways of adapting the user interface features may be represented by a set of user interface parameters, each having a set of values. For example, a first user interface parameter may indicate an adjustable speed for performing a sequence of user interface actions, another user interface parameter may determine the number of steps to be included in such a sequence; yet another user interface parameter may be a pointer to a video or animation illustrating a certain task, etc. Table 2 below illustrates an example of a table listing the rules for determining user interface-parameters for a given analyzer type:

TABLE 2
Rules for determining operator-parameter parameters

| Condition | UI Parm | Value |
|---|---|---|
| No. of occurrences of | INTRO_VIDEO_1 | <link to detailed training |
| error code 123 during the | | video> |
| last 10 operations is | | |
| greater than or equal to 5 | | |
| No. of occurrences of | INTRO_VIDEO_1 | <link to short training |
| error code 123 during the | | video> |
| last 10 operations is | | |
| smaller than 5 but greater | | |
| than 1 | | |
| No. of occurrences of | INTRO_VIDEO_1 | Void |
| error code 123 during the | | |
| last 10 operations is 0 or | | |
| 1. | | |
| . . . | . . . | . . . |

Each entry in the table specifies a condition, a user interface parameter and a value. Each entry thus represents a rule of the form

IF (condition) THEN (UI_Parm=Value)

Hence, each entry specifies under which condition a given user interface parameter is to be set to a certain value.

Based on the usage history records, the rule engine may then process all entries in the rules table and, for each entry, determine whether the condition is true and, if this is the case, set the given user interface parameter to the corresponding value identified in the table. When the rule engine has completed the processing of all rules, the rule engine sends a response 313 to the medical analyzer including the determined user interface parameter values.

Hence, in the above embodiment, the result of each evaluation of one of the conditions based on the usage history data represents an operator proficiency indicator (for example: “the number of occurrences of error code 123 during the last 10 operations is smaller than 5 but greater than 1” represents a proficiency indicator for a given operator). The rules table thus provides a mapping between the operator proficiency indicator and a specific adaptation of the user interface.

The conditions may use usage statistics parameters as described herein. Generally, examples of usage statistics parameters suitable for determining the proficiency level of an operator include:

The evaluation is individual and based on a number of criteria, such as:
Time since the operator last used the instrument.
The success rate of the operator of completing a measurement of the operator's last 10 samples.
The operators experience, such as the operators total number of samples run.
Time since the operator last completed the training.
Other evaluation criteria could be included.

It will be appreciated that more complicated rule engines may be designed which may use a variety of data analysis techniques for determining operator proficiency indicators and/or for mapping proficiency indicators to user interface adaptations.

It will further be appreciated that the conditions, rules and criteria used for adaptation of the user interface may be
made dependent on the placement/location of the analyzer,
modified for different operator groups; e.g. specialized operators doing difficult/more error prone sampling may be allowed a higher error rates before being presented with training or alterations of the user interface.

FIG. 5 shows a schematic block diagram of another example of a rule engine 520 implemented by a data processing system. The rule engine 520 of FIG. 5 is similar to the rule engine 420 of FIG. 4 but performs the determination of user interface parameters as a two-step process based on the usage history 421 and two sets of rules 523 and 524, all stored in a database 108. Rule engine 520 determines the user interface parameters responsive to a request 311 for user interface parameters, and provides the requested parameters in a response message 313 or via another suitable interface. During a first step, the rule engine 520 uses the usage history data 421 and a first set of rules 523 to determine a set of proficiency levels 525. The set of proficiency levels may consist of a single proficiency level which may have a number or a range of possible values e.g. values between 1 and 10 where 10 represents an expert operator while 1 represents a novice or very inexperienced operator. In other embodiments, the set of proficiency levels may include a plurality of levels, e.g.

individual levels for respective aspects of the operation of the medical analyzer such as individual levels representing the proficiency of an operator in performing certain tasks with the medical analyzer, e.g. different types of measurements, different types of specimen, different maintenance tasks, etc. The first set of rules 523 may have a structure similar to that shown in table 2, but for setting the proficiency levels instead of the user interface parameters.

The second set of rules 524 may thus comprise rules for mapping sets of proficiency levels to sets of user interface parameters. Accordingly, in a second step, the rule uses the result of the first step and the rules of the second set of rules 524 to determine a set of user interface parameters 526 and forwards the resulting user interface parameters to the medical analyzer as described above. The splitting up of the determination of the user interface parameters as in the example of FIG. 5 allows implementations where the second step may be implemented by the medical analyzer instead of the host system. In such an embodiment, the second set of rules 524 may be stored locally in the medical analyzer, and the rule engine of the host system would forward the proficiency level(s) to the medical analyzer rather than the user interface parameter values.

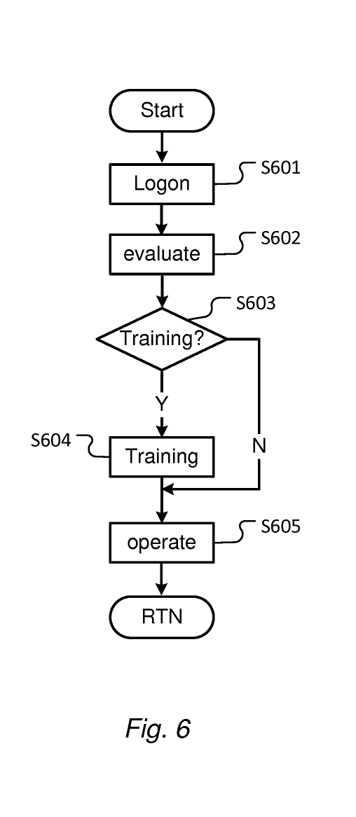

FIG. 6 shows a flow diagram of yet another example of a process for operating a medical analyzer. In the example of FIG. 6, the medical analyzer is a blood gas analyzer; however, it will be appreciated that this and other embodiments of the process may be performed on other types of medical analyzers, such as other types of clinical instruments.

In initial step S601, the operator logs on to the instrument. In subsequent step S602, the process automatically evaluates the operator history.

The evaluation is individual for the specific operator and is based on a number of criteria, such as:
The time since the operator last used the instrument.
The success rate of the operator of completing a measurement of the operator's last 10 samples.
The operator's experiences, such as the operator's total number of samples run on the instrument.
The period since the last training, e.g. a flag may be raised if it has been 90 days since the training was last completed.

It will be appreciated that alternative or additional evaluation criteria could be included.

Combined with a host system, such as a centralized data management system, the evaluation may be extended to the operator's action on any instrument of a specific type connected to the data management system, e.g. any instrument within the same hospital.

The data for the evaluation is continuously collected on the analyzer and/or centrally. An operator evaluation database is kept on the instrument and/or centrally.

Based on the evaluation, the process determines (step S603) whether the operator should be offered to see a short training video. If the process makes the determination that the operator should be offered an instructional video (step S604), completion of the video may be made mandatory. The process may also determine the topic of the instructional video, e.g. based on the above evaluation. For example, if an operator has had repeated problems with capillary samples, a video focusing on this issue may be shown. The training video may e.g. focus on how the operator can avoid pre-analytical errors and how the operator can properly and securely aspirate the sample.

The message introducing the training on the analyzer could be personalized:

“Welcome Nurse Jackie.

It has been 17 days since you last used this instrument.

Would you like to watch a short (30 seconds) introduction on how the instrument is operated?”

For example, a training video may demonstrate how to properly mix and aspirate a capillary sample and how to register the sample and collect the results. This video would be offered based on the evaluation of the operator's usage history and shown when the operator elects to see a short training video on how to run capillary samples on the analyzer. Text and sound may be added to the video for detailing and emphasizing important details.

By offering the training when the operator needs to use the instrument, the operator will be more likely to be motivated to follow the training. It will also be more likely that the operator has greater benefit of the training as this was done in close connection with the use of the instrument.

After completion of the training video the process continues at step S605 performing normal operation while collecting data for future evaluation responsive to subsequent logons by the same operator.

Some of the advantages of a selective, usage-history dependent training of operators upon logon include:
The operators are trained when necessary.
The operators are trained in the most important subjects.
The operators are trained when most motivated.
The number of pre-analytical errors is significantly reduced as the operators are trained more effectively.
The number of aspiration errors is significantly reduced as the operators are trained more effectively.
The reduction in sample error rate will result in a reduction in resampling rate and save time on sampling. The reduction in repeat sampling rate is especially important when sampling from patients with scarce blood volumes.
More efficient operation by experienced operators.

In the following additional examples of usage history data, their relation to an operator proficiency level, and the resulting user interface adaptations, such training on the specific analyzer, will be briefly summarized:
1) The process has detected that during previous operator sessions, the quality of the sample was not sufficient to obtain valid results:
   If the analyzer has repeatedly detected that clot was suspected in previous samples, a training video on ways to avoid clots may be presented during the next logon.
   If the analyzer has repeatedly detected that bubbles were present in samples, a training video on ways to avoid bubbles may be presented during the next logon.
   If the analyzer has repeatedly detected that insufficient sample volume was provided during previous sessions, a training video on ways to perform measurement may be present during the next logon.
2) The process has detected that during previous operator sessions, aspiration was frequently aborted due to errors in the aspiration process:
   If the analyzer has repeatedly detected that no sample was detected in previous sessions, a training video on ways to aspirate samples may be presented during the next logon.
   If the analyzer has repeatedly detected that the sample inlet was left open during previous sessions, a training video on ways to aspirate sample may be presented during the next logon.
   If the analyzer has repeatedly detected that the sample inlet was closed too soon during previous sessions, a training video on ways to aspirate sample may be presented during the next logon.

Other proficiency indicators that are detectable by embodiments of a blood gas analyzer include:
1) The analyzer may detect that, during previous operator sessions, the operator has had issues choosing and/or following the correct measurement process, e.g. by detecting repeated changes/alterations/corrections in the selection of various parameters during the measurement process, or by detecting repeated failure to follow certain process steps, such as:
   Difficulties in choosing sampler types (syringe/capillary)
   Difficulties in choosing measuring modes
   Failure to use a mixer of the analyzer for mixing a sample
   Failure to perform preregistration
2) The insecurity of the operator may be evaluated based on the time the operator takes to perform certain steps in the measurement procedure:
   The time the operator uses to choose a mode of operation
   The time the operator uses to present the sample
   The time the operator uses to perform the measurement
   The time the operator uses to remove the sampler, when aspiration is complete
   The time since the operator last used the analyzer/a specific feature

Specific examples of how a selective, usage-history dependent and operator-specific adaptation of the operator interface as described herein may be used will be briefly illustrated in the following:

### EXAMPLE 1

The system has detected that a certain operator has a high frequency of clots in previous capillary samples. When the operator logs on the analyzer a guide demonstrating a number of tips to avoid clots in capillary samples is shown. The guidance may include but is not limited to the steps below:

Guidelines to minimize clot problems when measuring capillary samples:

1. Ensure sample is properly heparinized by using a pre-heparinized capillary

2. Ensure sample is properly heparinized by mixing the sample after sampling

3. Use a clot catcher when aspirating a sample

The guidance may be in the form of one or more screens, with or without one or more animations and/or videos demonstrating clot risk reducing behavior. Videos will only be shown to operators where determined necessary, thus not delaying proficient operators.

The guidance may include one or more requests for confirmation of performance of the desired behavior.

Once the guidance is completed successfully, the normal measuring workflow is initiated as usual.

### EXAMPLE 2

The system has detected that a certain operator has a poor history of solution pack replacement. Poor history could be: failed installation, badly activated solution pack, long time used for replacement procedure, or few replacements within a predetermined period (e.g. a predetermined number of months).

The replacement of a solution pack normally requires 5 steps. These 5 steps include 5 additional sub-steps. When the operator with a detected poor previous performance initiates the process for replacing the solution pack, the workflow would be adapted to include all 10 steps as individual steps. For each individual step a confirmation is required. The additional steps would prolong the time needed for replacement by an experienced operator. But as it has been determined through data analysis the current operator is not experienced and requires the additional guidance. The additional steps and additional time is used to ensure that the replacement is successful.

Although some embodiments have been described and shown in detail, the invention is not restricted to them, but may also be embodied in other ways within the scope of the subject matter defined in the following claims.

For example, the determination of an operator proficiency level may be supplemented by a grouping of operators into operator groups, such as service technicians, super-operators, operator, and/or the like. These operator groups may determine access rights and user interface adaptations in addition to the adaptations based on proficiency levels. In some embodiments, the determination of proficiency levels described herein may be used to automatically allocate operators to selected ones of the operator groups where the operator groups reflect respective proficiency levels.

The method, product means, system, and analyzer described herein can be implemented by means of hardware comprising several distinct elements, and/or partly or completely by means of a suitably programmed microprocessor. In the analyzer claims enumerating several means, several of these means can be embodied by one and the same item of hardware, e.g. a suitably programmed microprocessor, one or more digital signal processor, or the like. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, integers, steps or components but does not preclude the presence or addition of one or more other features, integers, steps, components or groups thereof.

1. A method of operating a set of one or more medical analyzers each operable to analyze one or more specimens upon login of one of a set of one or more operators, the method comprising:
verifying identification of said operator;
collecting one or more sets of performance history data associated with the logged-in operator, each set associated with an operational task performed by one of the set of medical analyzers when operated by said one or more operators, wherein the operational task comprises an analysis of one or more specimens and/or a maintenance task, the performance history data being indicative of one or more performance measures of operating the medical analyzer;
determining, from at least the collected one or more sets of performance history data, one or more operator preferences and/or operator proficiency indicators indicative of a level of proficiency of the one or more operators; and
automatically adapting, responsive to the determined one or more operator preferences and/or proficiency indicators, one or more elements of a user interface of at least a first one of the set of medical analyzers when said first medical analyzer is operated by the one or more operators.

2. The method according to claim 1, further comprising storing the collected one or more sets of performance history data by a data processing system communicatively connected with each of the one or more medical analyzers.

3. The method according to claim 1, wherein at least one of the set of one or more medical analyzers is an analyzer for analyzing a sample of a bodily fluid.

4. The method according to claim 1, wherein at least one of the one or more sets of performance history data comprises:
one or more error codes;
one or more quality parameters indicative of a result of the analysis of a specimen;
performance data indicative of a quality of a specimen preparation step prior to bringing the specimen into contact with the medical analyzer;
timing information indicative of a time spent by the one or more operators performing the one or more predetermined steps;
an indication and/or an order of steps performed by the operator when operating the medical analyzer;
profile data of the operator;
an elapsed time since a previous performance of the operational task by said operator; and/or
a frequency of performing the operation task by said operator.

5. The method according to claim 1, wherein the determining of one or more operator proficiency indicators comprises comparing the collected performance history data with one or more reference criteria, and selecting a proficiency level from a set of proficiency levels responsive to said comparison.

6. The method according to claim 1, wherein the determining of the one or more operator proficiency indicators comprises processing the collected performance history data so as to identify one or more likely operational deficiencies in the operation of the medical analyzer.

7. The method according to claim 1, further comprising collecting performance history data associated with a plurality of medical analyzers; and wherein the determining comprises determining the one or more operator proficiency indicators and/or operator preferences of the one or more operators from the performance history data collected from said plurality of medical analyzers.

8. The method according to claim 1, wherein the user interface comprises a graphical user interface adapted to display respective user interface elements associated with one or more steps of an operator-controllable task performed by the medical analyzer; and wherein adapting the graphical user interface comprises adapting the number of user interface elements displayed for said operator-controllable task.

9. The method according to claim 1, wherein the user interface comprises a graphical user interface adapted to display respective user interface elements associated with one or more steps of an operator-controllable task performed by the medical analyzer; and
wherein adapting the graphical user interface comprises adapting a visual characteristic of one or more of the user interface elements displayed for said operator-controllable task.

10. The method according to claim 1, wherein the user interface is operable to perform at least one user interface action at a predetermined speed; and wherein adapting the user interface comprises selecting said predetermined speed.

11. The method according to claim 1 wherein the user interface is operable to perform a sequence of user interface actions; and wherein adapting the user interface comprises adapting a timing of the sequence of user interface actions relative to each other.

12. The method according to claim 1, wherein adapting the user interface comprises selecting one or more training presentations to be presented to the one or more operators.

13. The method according to claim 1, wherein adapting the one or more elements of a user interface comprises receiving the identification of an the operator of one of the set of one or more medical analyzers; and adapting the one or more elements of the user interface responsive to the received identification and to the determined one or more operator proficiency indicators and/or operator preferences.

14. The method according to claim 1, wherein adapting the one or more elements of a user interface comprises adapting the one or more elements of the user interface responsive to at least one of a location of the medical analyzer and a current time.

15. The method according to claim 1 wherein adapting the one or more elements of the user interface comprises disabling one or more functions of the medical analyzer.

16. The method according to claim 1, wherein adapting the one or more elements of the user interface comprises selecting a proficiency level from a number of available proficiency levels, each of the proficiency levels having a user interface type associated with it.

17. A medical analyzer for analyzing a specimen, the medical analyzer being configured to perform the method according to claim 1.

18. A system comprising a plurality of medical analyzers and a data processing system, the system being adapted to perform the method according to claim 1.

19. A computer program product comprising program code means adapted to cause a data processing system to perform the method according to claim 1, wherein the program code means are executed by the data processing system.
